(19) United States
(12) Patent Application Publication
(10) Pub. No.: US 2011/0035484 A1
(43) Pub. Date: Feb. 10, 2011

(54) METHOD AND SYSTEM FOR CREATING AND MANAGING A VARIABLE NUMBER OF VISIBLE INTERNET PROTOCOL (IP) ADDRESSES

(75) Inventor: Victor I. Sheymov, Vienna, VA (US)

Correspondence Address: The Villamar Firm PLLC, 3424 Washington Drive, Falls Church, VA, 22041, US

(73) Assignee: INVICTA NETWORKS, INC., Reston, VA (US)

(21) Appl. No.: 12/937,254

(22) PCT Filed: Mar. 26, 2009
(86) PCT No.: PCT/US09/38329

§ 371 Date: Oct. 9, 2010

Related U.S. Application Data
(60) Provisional application No. 61/044,871, filed on Apr. 14, 2008.

(51) Int. Cl. G06F 15/173

(52) U.S. Cl. 709/223

(57) ABSTRACT

A method, system and device for creating and managing a variable number of visible cyber coordinates, including at least one of means for generating a random or deterministic number; means for generating variable visible cyber coordinates based on the generated number; and means for employing the variable visible cyber coordinates during communications.

CROSS REFERENCE TO RELATED DOCUMENTS

The present invention claims benefit of priority to U.S. Provisional Patent Application Ser. No. 61/044,871 of Sheymov, entitled “METHOD AND SYSTEM FOR CREATING AND MANAGING A VARIABLE NUMBER OF VISIBLE INTERNET PROTOCOL (IP) ADDRESSES,” filed on Apr. 14, 2008, the entire disclosure of which is hereby incorporated by reference herein.

### BACKGROUND OF THE INVENTION

1. Field of the Invention

The present invention generally relates to systems and methods for secure communications, and more particularly to a system and method for creating and managing a variable number of visible Internet Protocol (IP) addresses.

2. Discussion of the Background

In recent years, communications and communications security systems have employed various techniques resulting in appearance of a single, sometime variable, Internet Protocol (IP) address at a gateway, while in fact there are multiple computers communicating from behind that gateway. For example, an InvisiLAN system or network employs Variable Cyber Coordinates (VCC) for a transmitter and receiver and which are not constant, but rather are constantly, and rapidly changing, wherein new coordinates are communicated only to authorized parties. The Cyber Coordinates can include any suitable address employed in any suitable communications system, such as a computer IP address or port, a telephone number, a Media Access Control (MAC) address, Ethernet Hardware Address (EHA), and the like. FIG. 1 illustrates a background art IP version 4 (IPv4) address.

However, even with secure systems, such as the InvisiLAN system or network, there is still a need to further conceal the visible IP address for providing further robustness to such systems.

### SUMMARY OF THE INVENTION

Therefore, there is a need for a method and system that address the above and other problems with secure systems. The above and other needs are addressed by the exemplary embodiments of the present invention, which provide a novel method and system for creating and managing a variable number of visible Internet Protocol (IP) addresses, and which can be used with secure systems, such as an InvisiLAN system, and the like.

A method, system and device for creating and managing a variable number of visible cyber coordinates are provided, including at least one of means for generating a random or deterministic number; means for generating variable visible cyber coordinates based on the generated number; and means for employing the variable visible cyber coordinates during communications.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates a background art IP version 4 (IPv4) address;

FIG. 2 illustrates an exemplary system that can be used for creating and managing a variable number of visible Internet Protocol (IP) addresses;

FIG. 3 illustrates a background art IP version 4 (IPv4) packet;

FIGS. 4A-4D illustrate four machines communicating in the exemplary system of FIG. 2;

FIG. 5 illustrates four machines communicating in the exemplary system of FIG. 2, without creating and managing a variable number of visible IP addresses;

FIG. 6 illustrates four machines communicating in the exemplary system of FIG. 2, while creating and managing a variable number of visible IP addresses; and

FIG. 7 illustrates an exemplary flow chart for creating and managing a variable number of visible IP addresses.

### DETAILED DESCRIPTION OF THE PREFERRED EMBODIMENTS

The present invention includes recognition that there can he various reasons for creating a single, sometime variable, Internet Protocol (IP) address at a gateway, for example, including conservation of the IP address space, which particularly important for the IP version 4 (IPv4) protocol, security considerations, and the like. In addition, such techniques make it more difficult for an interceptor to process a packet stream, for example, for cryptographic analysis. As noted above, the InvisiLAN system or network employs Variable Cyber Coordinates (VCC) for a transmitter and receiver and which are not constant, but rather are constantly, and rapidly changing, wherein new coordinates are communicated only to authorized parties. The Cyber Coordinates can include any suitable address employed in any suitable communications system, such as a computer IP address or port, a telephone number, a Media Access Control (MAC) address, Ethernet Hardware Address (EHA), and the like. The InvisiLAN system is further described on the World Wide Web (e.g., at invictanetworks.com).

Advantageously, the exemplary embodiments introduce further variability and dynamics into such systems, wherein the number of “visible” IP addresses is made variable and changes, for example, deterministically or randomly, and the like. The exemplary embodiments can be applied to any suitable secure system, such as the InvisiLAN system, and the like. However, the teachings of the exemplary embodiments are applicable to other types of networks or systems where there is a need for hiding or concealing visible IP addresses, as will be appreciated by those skilled in the relevant art(s).

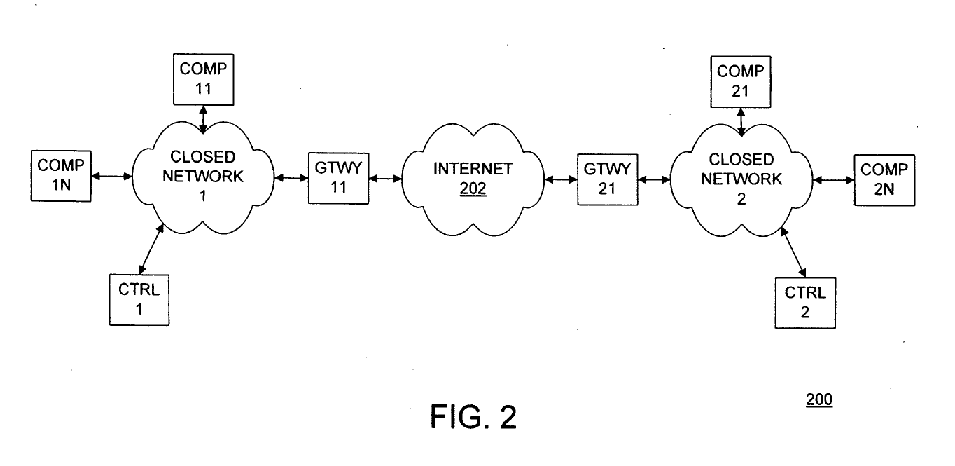

Referring now to the drawings, FIG. 2 thereof illustrates an exemplary system 200 for creating and managing a variable number of visible Internet Protocol (IP) addresses and for providing further robustness to security of communication systems. In FIG. 2, closed communications network or system 1 includes one or more computers or devices 11 . . . 1N, gateway 11 (e.g., a router, a computer, etc.), and controller 1 (e.g., a secure server, a secure computer, a secure computing device, etc.) for providing communication over an unsecured network 202, such as the Internet, with closed communications network or system 2. Similarly, closed communications network or system 2 includes one or more computers or devices 21 . . . 2N, gateway 21 (e.g., a router, a computer, etc.), and controller 2 (e.g., a secure server, a secure computer, a secure computing device, etc.) for providing communication over the unsecured network 202, such as the Internet, with closed communications network or system 1. Examples of the systems 1 and 2 can include any suitable closed communications networks or systems, such as the InvisiLAN systems, and the like.

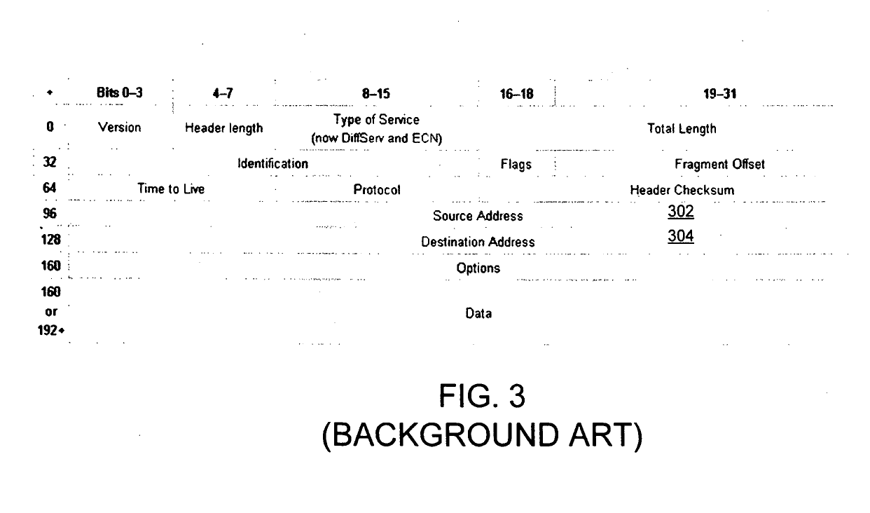

In the case of the InvisiLAN system, the controllers 1 and 2 are configured to create and manage the Variable Cyber Coordinates (VCC), which can include an IP address, for a transmitter and receiver and which are not constant, but rather are constantly, and rapidly changing, wherein new coordinates are communicated only to authorized parties within the closed communications networks or systems 1 and 2. FIG. 3 illustrates a background art IP version 4 (IPv4) packet, wherein the controllers 1 and 2 of the system of FIG. 2 constantly, and rapidly change the visible IP source 302 and destination 304 addresses of the authorized parties within the closed communications networks or systems 1 and 2 to provide security. In addition, although such a system can employ an expansion of the IP address space, such a system nonetheless leaves the “visible” part of the available IP addresses to be “visible” to an observer on the closed communications network or system 1 or 2 or in a position between the two sites such as in the “man-in-the-middle attack”. As noted above, the exemplary embodiments introduce further variability and dynamics into such systems, wherein the number of such “visible” but changing IP addresses is made variable and changes, for example, deterministically or randomly, and the like. Thus, the exemplary embodiments can be used to provide even further security to such systems.

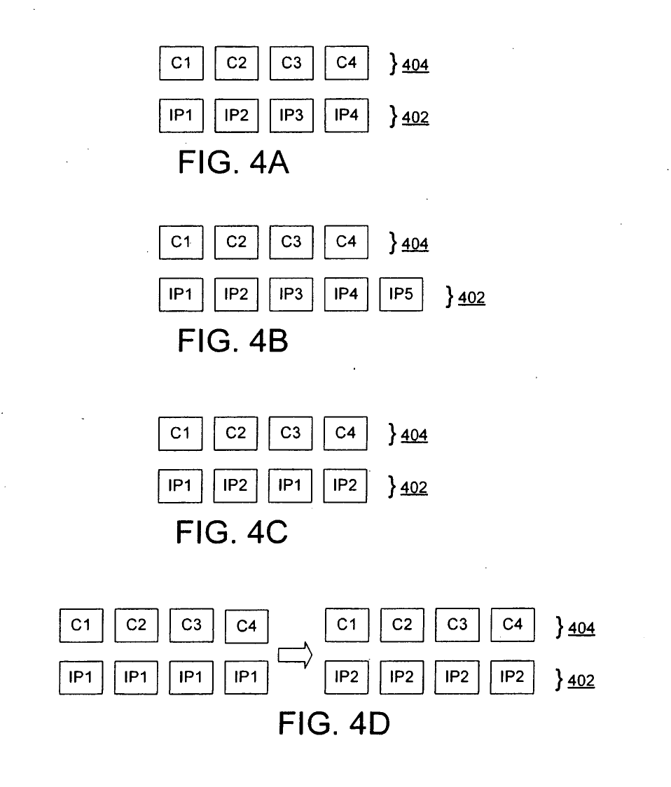

Generally, n IP addresses usable for the network devices are assigned to a network. For example, Class C networks are assigned 256 addresses (i.e., n=254) and in a classic case i=k shown in FIG. 4A (i=k=4), where i is a number of “visible” IP addresses 402 (IP1-IP4), and k is a number of communicating computers 404 (C1-C4). Generally, however, i can be made to appear so it can be described as:

1≦i≦n

With the above formulation, for a case when i≧k shown in FIG. 4B (i=5, k=4), an observer or attacker, given sufficient observation time, can relatively easily calculate k, for example, which would enable the observer to proceed with further cryptographic analysis. If i≦k (e.g., using techniques similar to Dynamic Host Configuration Protocol (DHCP), and the like), as shown in FIG. 4C (i=2, k=4), this becomes more difficult, and the attacker has to deploy additional capabilities to calculate k, as is the case with some modern day systems. If according to the exemplary embodiments, however, not only i≦k, but also i is made variable, as shown in FIG. 4D (i=2 variable, k=4), the situation is much more difficult for the attacker and the attacker must now perform significant additional processing before even starting the cryptographic analysis process to successfully launch an attack. In addition, with a sufficient frequency of changes in the value of i, advantageously, it possible to further complicate the task for an outside attacker by making 1≦i≦n.

For example, assuming four machines (S1, S2 and D1, D2, k=4, where S=source and D=destination machines) are communicating in the exemplary system 200 with four visible but changing IP addresses (i=4), an observer would see source (IP11 S1 . . . IP1N S1, IP21 S2 . . . IP2N S2) and destination (IP31 D1 . . . IP3N D1, IP41 D2 . . . IP4N D2) addresses corresponding to the four machines, as shown in FIG. 5. Even though such visible source and destination addresses can be changing (e.g., IP11 S1 changes to IP12 S1 to IP1N S1, IP21 S2 changes to IP22 S2 to IP2N S2, IP31 D1 changes to IP32 D1 to IP3N D1, and IP41 D2 changes to IP42 D2 to IP4N D2), the observer could still gather intelligence about the system 200 based on such visible, but changing IP addresses.

Accordingly, the exemplary embodiments introduce further variability and dynamics into the above situation by configuring the number of such visible but changing IP addresses i to be less than the number of computers k, and to he made variable and changing, for example, either deterministically or randomly. In an exemplary embodiment, the number k of hosts (e.g., one or more of the computers or devices 11 . . . 1N, 21 . . . 2N, etc.) can be set higher than the visible portion of the IP addresses i, and that visible portion i can change, revealing to an outside observer i number of utilized but changing visible IP addresses, and satisfying 1≦i≦k. In an exemplary embodiment, i can be changed from time to time or based on an event, and the like, so as to be variable.

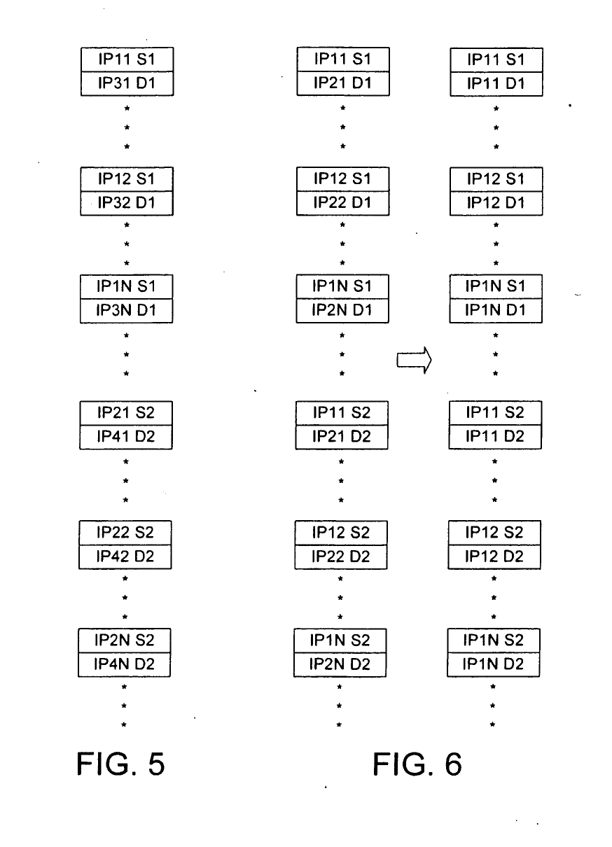

FIG. 6 illustrates an example where four machines (S1, S2 and D1, D2, k=4, where S=source and D=destination machines) are communicating in the exemplary system 200 using two visible but changing IP addresses (i=2 variable). Advantageously, a hacker would have a difficult time gathering intelligence about the system 200 based on such visible, but changing IP addresses and where 1≦i≦k.

Thus, the exemplary embodiments can make an interceptor's job considerably more difficult. For example, as shown with FIG. 6, even though four machines may be communicating on the system 200, an observer would see a number of visible IP addresses changing in time from 1 to 4, thus advantageously further concealing the communications of the four machines. Specifically, for cryptanalytic processing of a packet stream from and to a target network, it is necessary to sort out the packet stream with proper allocation to specific crypto keys, Random Number Generators (RNGs), and the like. Typically, this includes allocation to specific computers within the network being attacked. This task becomes computationally more difficult with the number of “visible” IP addresses being randomized.

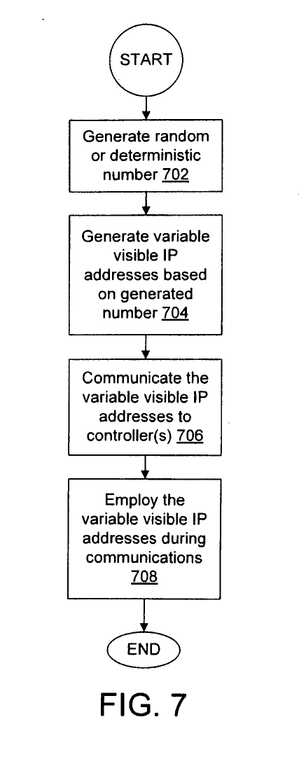

FIG. 7 illustrates an exemplary flow chart for creating and managing a variable number of visible IP addresses. In FIG. 7, the process begins at step 702 with a random or deterministic number being generated, for example, within the range 1≦i≦k by a computer or controller of the system 200. Based on the generated number, the IP addresses are variably generated at step 704. The variable IP addresses then are communicated, for example, to the controllers 1 and/or 2 at step 706, which then employ the variable visible IF addresses during communications at step 708, completing the process. The process for creating and managing a variable number of visible IP addresses can be repeated in a random or deterministic fashion so as to enhance the security of the system 200, as needed.

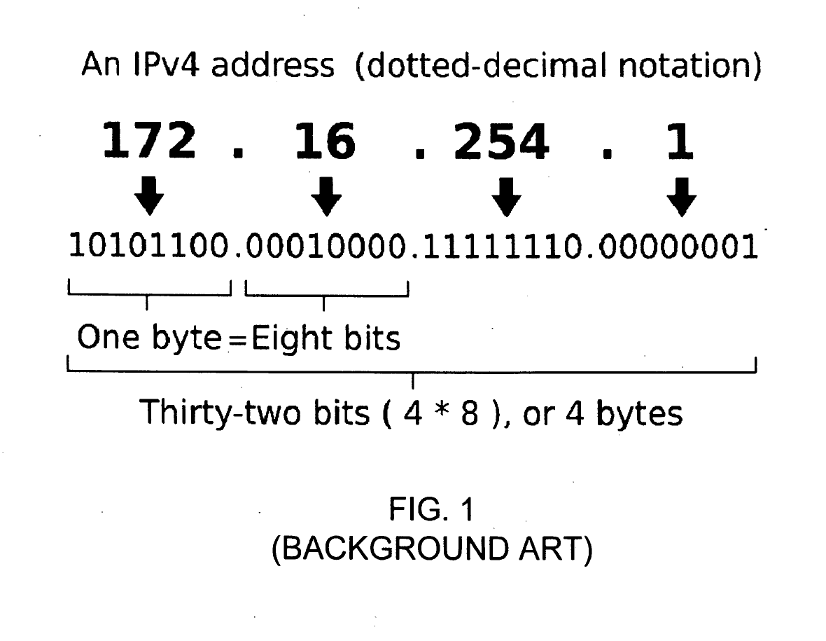

The above-described devices and subsystems of the exemplary embodiments of FIGS. 1-7 can include, for example, any suitable servers, workstations, PCs, laptop computers, PDAs, Internet appliances, handheld devices, cellular telephones, wireless devices, other electronic devices, and the like, capable of performing the processes of the exemplary embodiments of FIGS. 1-7. The devices and subsystems of the exemplary embodiments of FIGS. 1-7 can communicate with each other using any suitable protocol and can be implemented using one or more programmed computer systems or devices.

One or more interface mechanisms can he used with the exemplary embodiments of FIGS. 1-7, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the exemplary embodiments of FIGS. 1-7 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1-7 can be implemented via one or more programmed computer systems or devices.

To implement such variations as well as other variations, a single computer system can he programmed to perform the special purpose functions of one or more of the devices and subsystems of the exemplary embodiments of FIGS. 1-7. On the other hand, two or more programmed computer systems or devices can be substituted for any one of the devices and subsystems of the exemplary embodiments of FIGS. 1-7. Accordingly, principles and advantages of distributed processing, such as redundancy, replication, and the like, also can be implemented, as desired, to increase the robustness and performance the devices and subsystems of the exemplary embodiments of FIGS. 1-7.

The devices and subsystems of the exemplary embodiments of FIGS. 1-7 can store information relating to various processes described herein. This information can be stored in one or more memories, such as a hard disk, optical disk, magneto-optical disk, RAM, and the like, of the devices and subsystems of the exemplary embodiments of FIGS. 1-7. One or more databases of the devices and subsystems of the exemplary embodiments of FIGS. 1-7 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-7 can include appropriate data structures for storing data collected and/or generated by the processes of the devices and subsystems of the exemplary embodiments of FIGS. 1-7 in one or more databases thereof.

All or a portion of the devices and subsystems of the exemplary embodiments of FIGS. 1-7 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1-7 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-7, for driving the devices and subsystems of the exemplary embodiments of FIGS. 1-7, for enabling the devices and subsystems of the exemplary embodiments of FIGS. 1-7 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1-7. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-7 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

Although the exemplary embodiments are described in terms of the InvisiLAN systems or networks, the teachings of the exemplary embodiments can he used with any other suitable systems or networks, as will be appreciated by those skilled in the relevant art(s).

Although the exemplary embodiments are described in terms of the IP version 4 (IPv4) protocol, the teachings of the exemplary embodiments can he used with any other suitable protocols, such as the IP version 6 (IPv6) protocol, any other suitable communications protocol, and the like, as will be appreciated by those skilled in the relevant art(s).

Although the exemplary embodiments are described in terms of employing IP addresses, the teachings of the exemplary embodiments can be used with any other suitable coordinates, such as a computer port, a telephone number, a Media Access Control (MAC) address, Ethernet Hardware Address (EHA), and the like, as will be appreciated by those skilled in the relevant art(s).

While the present invention have been described in connection with a number of exemplary embodiments and implementations, the present invention is not so limited, but rather covers various modifications and equivalent arrangements, which fall within the purview of the appended claims.

1-6. (canceled)

7. A system for creating and managing a variable number of visible cyber coordinates, the system comprising:
a random or deterministic number generator for generating a random or deterministic number;
a variable visible cyber coordinate generator for generating variable visible cyber coordinates based on the generated number; and
a communications system employing the variable visible cyber coordinates during communications.

8. The system of claim 7, wherein the cyber coordinates are IPv4 or IPv6 addresses, or an address of a communications protocol.

9. A method for creating and managing a variable number of visible cyber coordinates, the method comprising:
generating a random or deterministic number by a random or deterministic number generator;
generating variable visible cyber coordinates based on the generated number by a variable visible cyber coordinate generator; and
employing the variable visible cyber coordinates during communications by a communications system.

10. The method of claim 9, wherein the cyber coordinates are IPv4 or IPv6 addresses, or an address of a communications protocol.

11. A computer program product for creating and managing a variable number of visible cyber coordinates, and including one or more computer readable instructions embedded on a computer readable medium and configured to cause one or more computer processors to perform the steps of:
generating a random or deterministic number by a random or deterministic number generator;
generating variable visible cyber coordinates based on the generated number by a variable visible cyber coordinate generator; and
employing the variable visible cyber coordinates during communications by a communications system.

12. The computer program product of claim 11, wherein the cyber coordinates are IPv4 or IPv6 addresses, or an address of a communications protocol.
